(19) United States
(12) Patent Application Publication
(10) Pub. No.: US 2004/0113887 A1
(43) Pub. Date: Jun. 17, 2004

(54) partially real and partially simulated modular interactive environment

(75) Inventors: Jackson Jarrell Pair, Marina Del Rey, CA (US); Ulrich Neumann, Manhattan Beach, CA (US); William R. Swartout, Malibu, CA (US); Richard D. Lindheim, Beverly Hill, CA (US)

Correspondence Address: MCDERMOTT, WILL & EMERY, Suite 3400, 2049 Century Park East, Los Angeles, CA, 90067, US

(73) Assignee: University of Southern California

(21) Appl. No.: 10/647,932

(22) Filed: Aug. 26, 2003

Related U.S. Application Data
(60) Provisional application No. 60/406,281, filed on Aug. 27, 2002.

(51) Int. Cl. G09G 5/00

(52) U.S. Cl. 345/156

(57) ABSTRACT

An interactive environment that is partially real and partially simulated. The environment may include a structure, at least one real, three-dimensional object, at least one computer-controlled display, at least one sensor, and a processing system in communication with the display and the sensor. The processing system may be configured to deliver a sequence of images to the display, the content of which may be a function of the interaction between the individual and the scene. The structure, real object and images on the display may cooperate to form a seamless and integrated scene. Construction in the form of a modular system is also disclosed.

### CROSS-REFERENCE TO RELATED APPLICATIONS

This application is based upon and claims the benefit of the filing date of U.S. provisional application, serial No. 60/406,281, filed Aug. 27, 2002, entitled “Immersive System of Digital Walls and Physical Props,” the entire content of which is incorporated herein by reference.

### BACKGROUND OF INVENTION

1. Field of Invention

This application relates to virtual reality systems, including virtual reality systems that simulate a real environment.

2. Description of Related Art

It is often helpful to simulate a real environment to test one or more individuals or to train them to better cope with the real environment.

Conducting the test or training in the real environment is often more realistic. However, it is also often impractical. The real environment might pose dangers to the individuals, such as in a hostage situation or the repair of a contaminated nuclear reactor. Failure of the individual to succeed with his effort in the real environment might also lead to catastrophic losses. The real environment might also not be readily accessible or available.

Mock-ups have been made as part of an effort to meet this need. Sometimes, however, the mock-ups take too long to create, cost too much money, are difficult to reconfigure, and/or are hard to transport. Mock-ups also sometimes lack a sense of realism.

The projection of images on screens has also been used. These presentations, however, also often lack realism. There is usually nothing real to touch or interact with, and the screen is often devoid of any surrounding context.

Head-mounted displays have also been used. Still, however, there is often nothing real to touch. These devices can also be heavy and seriously restrict movement.

### BRIEF SUMMARY OF INVENTION

An interactive environment may be partially real and partially simulated. It may include a structure that is large enough to accommodate an individual both before and after the individual takes a plurality of displacement steps within the structure. At least one real, three-dimensional object may be positioned within the structure, the real object and the structure cooperating to form a seamless and integrated scene. At least one computer-controlled display may be fixedly positioned within the scene such that each image displayed by the display appears to the individual to be real, three-dimensional and an integral and seamless part of the scene. At least one sensor may be configured to sense interaction between the individual and the scene. A processing system may be in communication with the sensor and the display and configured to deliver a sequence of images to the display, the content of which are a function of the interaction between the individual and the scene, including a plurality of displacement steps taken by the individual.

The display may be configured and positioned so as to appear to the individual to be an integrated and seamless part of the scene that is something other than a display. The display may be part of the structure.

The display may include a wall of the structure. One of the images may include an image of wall texture, and the processing system may be configured to deliver the image of the wall texture to the display.

A real, operable door may be positioned in front of the wall of the display.

A real window may be positioned in front of the wall of the display. The window may be operable such that it can be opened or closed. The window may include operable shutters.

The interactive environment may be configured to simulate a real environment having a similar structure, a similar real object and a scene beyond the structure. One of the images may include an image of the scene beyond the structure. The interactive environment may include a real or virtual door or window. At least a portion of the display may be oriented within the opening of the door or window. The processing system may be configured to deliver the image of the scene beyond the similar structure to the display.

One or more of the images may be selected by the processing system from a library of images stored on an image storage device.

The interactive environment may be configured to simulate a real environment and one or more of the images may be captured from the real environment. The images that are captured from the real environment may be delivered by the processing system to the display in real time.

The structure, display and real object may be configured in the form of modules that releasably connect to and disconnect from one another to facilitate the assembly, disassembly, shipment and re-assembly of the interactive environment in various different configurations. A portion of the structure, the display or the real object may include wheels for easy transport.

The structure may be large enough to accommodate a plurality of individuals both before and after each individual takes a plurality of displacement steps.

The structure, display and real object may cooperate to create the environment of a room.

The structure, display and real object may cooperate to create the environment of a building having a plurality of rooms.

The structure, display and real object may cooperate to create the environment of a land, sea or air vessel.

The interactive environment may include a computer-controlled sensory generator, other than a display, configured to controllably generate matter or energy that is detectable by one or more of the human senses. The processing system may also be in communication with the generator and configured to control the generation of such matter or energy. The processing system may be configured to control the generator as a function of the interaction between the individual and the scene.

The generator may include sound-generating apparatus.

The generator may include movement-generating apparatus. The movement generating apparatus may include floor movement generating apparatus. The movement generating apparatus may include air movement generating apparatus.

The generator may include a light.

The generator may include temperature-changing apparatus.

One or more images may be stereoscopic images. The display may be configured to display the stereoscopic images.

A distributed interactive environment may be partially real and partially simulated.

The distributed interactive environment may include a first computer-controlled display fixedly positioned within a first scene such that each image on the first display appears to a first individual in the first scene to be real, three-dimensional and an integral and seamless part of the first scene. A first sensor may be configured to sense interaction between the first individual and the scene.

The distributed interactive environment may include a second computer-controlled display fixedly positioned within a second scene such that each image on the second display appears to a second individual in the second scene to be real, three-dimensional and an integral and seamless part of the second scene. The second scene may be substantially the same as the first scene, but separated geographically from the first scene. A second sensor may be configured to sense interaction between the second individual and the second scene.

The distributed interactive environment may include a processing system in communication with the first and second displays and the first and second sensors. The processing system may be configured to deliver a sequence of images to the first display, the content of which are a function of the interaction between the second individual and the second scene. The processing system may also be configured to deliver a sequence of images to the second display, the content of which are a function of the interaction between the first individual and the first scene.

A modular, interactive environment may include a set of modular walls that releasably connect to and disconnect from one another to facilitate the assembly, disassembly, shipment and re-assembly of the interactive environment in various different configurations. At least one of the walls may be a computer-controlled display configured such that images on the display appear to an individual within the environment created by the walls to be real, three-dimensional and an integral and seamless part of the environment. At least one sensor may be configured to sense interaction between an individual and the environment created by the modular walls. A processing system may be in communication with the sensor and the display and configured to deliver images to the display that vary based on the interaction between the individual and the environment.

These, as well as other objects, features and benefits will now become clear from a review of the following detailed description of illustrative embodiments and the accompanying drawings.

### BRIEF DESCRIPTION OF DRAWINGS

FIG. 1 is an interactive environment that is partially real and partially simulated.

FIG. 2 is a lateral perspective view of the display wall shown in FIG. 1 with a real door in front of it.

FIG. 3 is a lateral perspective view of the display wall shown in FIG. 1 with a real window in front of it.

FIG. 4 is an interactive environment that is partially real and partially simulated of a different configuration.

FIG. 5 is a distributed interactive environment that is partially real and partially simulated.

FIGS. 6(a)-(c) are configurations of other interactive environments that include vessels.

### DETAILED DESCRIPTION OF ILLUSTRATIVE EMBODIMENTS

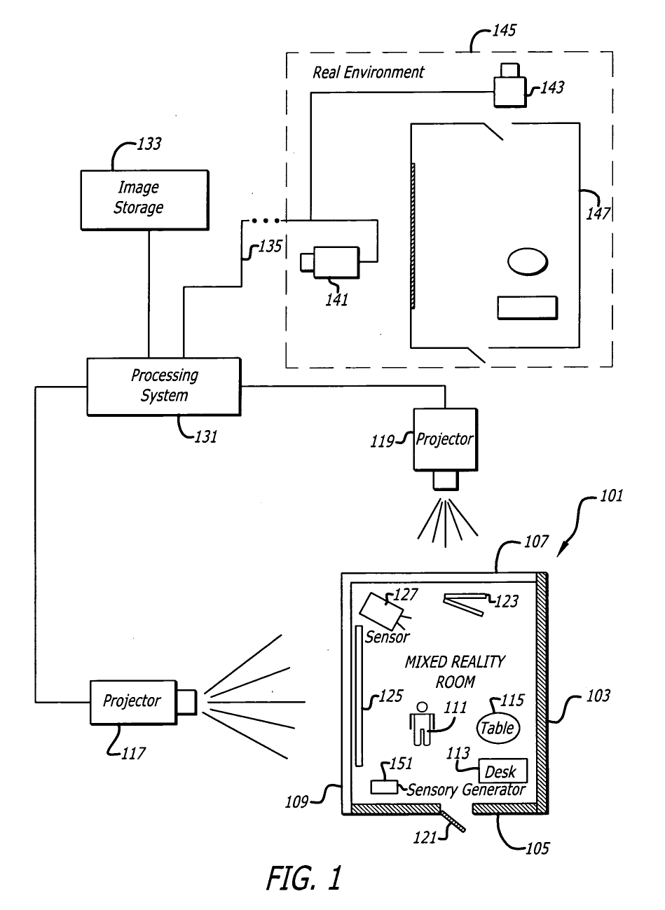

FIG. 1 is an interactive environment that is partially real and partially simulated.

As shown in FIG. 1, a structure 101 may include real walls 103 and 105. These may be constructed from props used in movie sets, i.e., from material that looks and acts like a wall, but is lighter, possibly thinner, and less expensive.

The structure 101 may also include display screen walls 107 and 109. Display screen walls 107 and 109 may be configured to look like walls, as illustrated in FIG. 1.

The walls 103, 105, 107 and 109 may be configured so as to create the appearance of a room. The room may be large enough to accommodate an individual 111 both before and after the individual 111 takes a plurality of steps displacing himself horizontally, vertically or in some other direction.

At least one real, three-dimensional object may be positioned within the structure 101, such as a desk 113 and a table 115. The real objects may cooperate with the structure 101 to form a seamless and integrated scene from the perspective of the individual 111.

The interactive environment may include one or more computer-controlled displays. In FIG. 1, two such computer-controlled displays are illustrated. One is a projector 117 directed toward the display screen wall 109. The other is a projector 119 directed toward the display screen wall 107. Each of these make up a rear-projection display. In each case, the display screen wall may consist of or include an opaque surface that radiates a quality image on the surface opposite of the surface that is illuminated by its associated projector.

Each computer-controlled display may be fixedly positioned relative to the structure 101 such that the display does not move during movement of the indivudal 111. Indeed, each computer-controlled display or, as shown in FIG. 1, a portion of the display may be part of the structure, as illustrated by the display screen walls 107 and 109 forming walls of the structure 101.

The computer-controlled display or displays may be configured and positioned so as to appear to the individual 111 as an integrated and seamless part of the scene that is created by the structure and real objects. This part of the scene may be something other than a display, such as the walls illustrated in FIG. 1.

The scene created by the structure 101 and the real objects 113 and 115 may be augmented by other real objects to enhance the realism of the scene to the individual 111. These other real objects may cooperate with the scene so to form a seamless and integrated part of the scene, again from the perspective of the individual 111.

One such other real object may be a real, operable door 121, a reference intended to also include the frame of the door. This may provide the individual 111 with a mechanism for entering the room that has been created and to enhance the realism of that room.

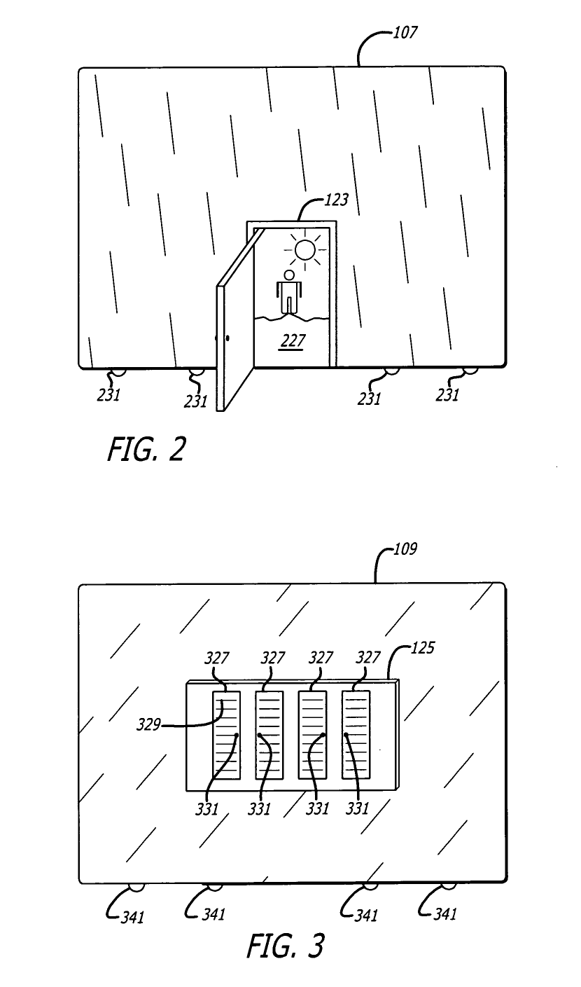

A still further real object may be a real, operable door 123, a reference intended to also include the frame of the door. This door may be positioned immediately in front of the display screen wall 107, forming a seamless and integrated part of the scene from the perspective of the individual 111 .FIG. 2 is a lateral perspective view of the display screen wall 107 shown in FIG. 1 with the real door 123 in front of it. The real door 123 is operable and thus may actually be opened by the individual 111, it being shown in open positions in both FIGS. 1 and 2. When the individual does open the door, the portion of the display screen wall 107 that lies behind the door may then becomes viewable to the individual 111. If, as described in more detail below, an image of a scene 227 is projected on the portion of the display screen wall 107 that is behind the door 123 by the projector 119, the individual 111 will see that scene and perceive it to be an integrated and seamless part of the scene that is created by the structure 101 and the real objects 113, 115 and 123. Of course, the individual 111 may not actually be able to step through the real door because of the display screen wall 107 behind it.

Returning to FIG. 1, a still further real object may be real window 125 placed in front of a display screen wall, such as the display screen wall 109. Again, the real window 125 may be constructed and positioned with respect to the structure 101 and the other real objects so as to be seamlessly integrated within the scene, again from the perspective of the individual 111. And again, the individual 111 may not actually be able to extend a hand through the window 125 because of the display screen wall 109 behind it.

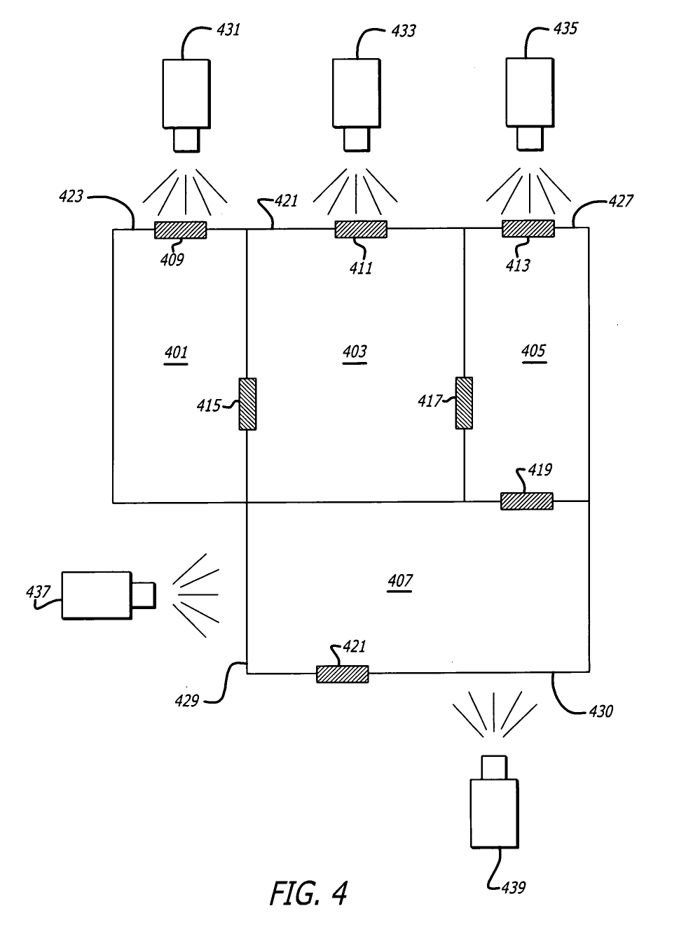

FIG. 3 is a lateral perspective view of the display screen wall 109 with the real window 125 in front of it. As shown n FIG. 3, the real window 125 may include real shutters 327, each of which may include adjustable louvers 329 and pull knobs 331. Similar to the door 123, the individual 111 will see images projected by the projector 117 on the portions of the display screen wall 109 that are directly behind the window 125 if the individual 111 opens a shutter by pulling on its knob 131 or adjusting its louvers 129.

Returning to FIG. 1, the interactive environment may also include one or more sensors, such as the sensor 127. The sensors may sense interaction between the individual 111 and the scene by detecting and/or measuring that interaction.

The interaction that the sensors detect or measure may precede the several displacement steps of the individual, may follow those steps, or may occur during the steps. Indeed, the interaction that is sensed may be the steps themselves.

The sensors may sense movement of the individual. In this case, the sensor could be a camera and associated signal interpretive system, an ultrasonic sensor, a UV sensor, or any other type of movement sensing device. The individual could also be instrumented with the movement sensor, such as a GPS receiver and an associated transmitter for transmitting the extracted coordinate information.

The sensors may sense contact of the individual with an object in the scene or proximity of the individual to that object. For example, the sensors might detect that a door or window has been opened or that a gun has been shot. In the gun shot example, the sensors might include a sensor on the portion of the display screen wall 107 that is behind the door 123 that sensors the location at which a laser beam intersects that portion of the screen. The sensors might include a sensor attached to a laser gun (not shown) that is held by the individual 111 that senses the location of the laser gun in three dimensional space. Using well-known triangulation techniques, the aim of the laser can then be computed from the information provided by these two sensors, followed by a determination of whether a particular target that might be a part of the image behind the door 123 has been hit.

The sensors may be configured to sense sound that is generated by the individual, such as by his voice or foot movement.

The sensors may be configured to sense the level of lighting in the room set by the individual 111 and hence the anticipated visibility of the individual 111 through a window or door opening.

The sensors may be configured to sense any other type of interaction between the individual and the scene.

Although a single sensor 127 is shown as being located in the corner of the structure 101 in FIG. 1, this is just to illustrate one example. Both the number and location of the sensors may vary widely, as suggested by the discussion above.

A processing system 131 may be included and configured to be in communication with the projectors 117 and 119 and the sensors, such as the sensor 127. The processing system 131 may also be in communication with an image storage system 133. The processing system 131 may also be in communication with a source of real-time image information over a communication link 135.

The processing system 131 may be configured to select and deliver appropriate images to the projectors 117 and 119 from the image storage system 133 and/or the source of real-time imagery over the communication link 135. The processing system 131 may be configured to cause the imagery that is selected to be delivered to the projector 117 and/or 119 to be a function of the interaction between the individual and the scene, including the plurality of displacement steps taken by the individual, as detected and/or measured by the sensors, such as the sensor 127. In this configuration, the sequence of images that is delivered to the projector 117 and/or the projector 119 are considered to be “non-linear” because the sequence is not wholly pre-determined, but rather a function of the interaction between the individual 111 and the scene, as detected by the sensors, such as the sensor 127.

The configuration that has thus-far been described in connection with FIG. 1 provides a broad variety of flexibility and associated effectiveness in the interactive environment that is simulated.

In connection with a military training exercise, for example, all of the louvers 329 in the shutters 327 in the window 125 may be in the closed position with the individual 111 standing by the real desk 113. The individual 111 may then walk over to the window 125 and open the louvers 329 on one of the shutters 327.

This opening may be detected by a sensor (not shown in FIG. 1). Upon this detection, the processing system 131 may be programmed to select a video of a sniper moving in position to fire from the library of images on the image storage device 133. It may also be programmed to deliver this image to the projector 117 such that this video is seen by the individual 111 while looking through the open louvers 329 in one of the shutters 327 in the window 125.

The individual 111 may then raise a laser gun (not shown), point it toward the virtual sniper, and fire. This interaction between the individual 111 and the scene may be sensed by other sensors, including the direction that the gun was fired. The processing system 131 may then compute whether the direction of the firing was sufficiently accurate to immobilize the sniper.

To do this, the processing system may need information about the location of the sniper. This information might be developed from the image supplied by the image storage system 133 or from independent data that is supplied along with this image or as part of it.

If the processing system 131 determines that the aiming was sufficiently accurate to immobilize the sniper, the processing system 131 may then a video of the sniper falling to the ground select from the image storage system 133 and deliver that image to the projector 117, thus communicating to the individual 111 that his firing was successful.

On the other hand, if the aim was not accurate, the processing system 131 might select a different image from the image storage system 133, such as an image of the sniper firing back. Information from the sensors about the exact location of the individual 111 may then be delivered to the processing system 131 at the moment that the sniper fires, thus enabling the processing system 131 to compute whether the individual was successful in moving out of the way in sufficient time. The determination of this computation by the processing system 131 may be communicated to the individual 111 or to others as part of the training or assessment of the individual 111.

As noted above, the display screen walls 107 and 109 may be large enough to appear to the individual 111 as an entire wall. In this configuration, the processing system 131 may be configured to deliver to the projectors 117 and 119 imagery of the desired interior texture of the walls 107 and 109, such as the appearance of bricks. This would cause the display screen walls 107 and 109 to appear to the individual 111 as real, brick walls.

Of course, the imagery that the individual 111 sees through the door 123 and the window 125 would most likely be different. To accomplish this, the image that is stored in the image storage system 133 may actually consist of two images, the image of the textured area of the walls outside of the door 123 and window 125 and the virtual scene image that needs to appear in the portals of the door 123 or window 125.

Alternatively, an overlay system may be used to overlay the images that should be seen in the portals on top of the texture images that appear around these portals. The needed texture could be separately stored as an image, such as in the image storage system 133. A single sub-area of the needed texture might instead be stored and replicated by the processing system 131 in the needed areas.

Of course, other imagery could be projected on the portions of the walls outside of the portals created by the door 123 and the window 125. For example, a video of a tank breaking through the wall might be projected in appropriate circumstances.

A broad variety of images may be delivered to the displays. They may include still pictures, videos, or a mixture of still pictures and videos. The images may be virtual images generated by a computer or real images. They may be stored in electronic format, such as in a digital or analog format. They may also be optically based, such as from film.

The images may be such as to appear to be real, three-dimensional and seamlessly integrated into the scene when displayed from the perspective of the individual 111.

By combining all these features, an individual can effectively walk or run in the simulated environment and interact with real and virtual components in the environment, just as though all of the components were real. This effectively creates a mixed reality world where the real and virtual are integrated and seamless co-exist.

The scene that is created by these components, including the structure 101, the display screen walls 107 and 109, the real objects 113, 115, 123 and 125, and the images that are delivered to the display screen walls 107 and 109 may cooperate to simulate a real environment, such as the real environment 145 shown in FIG. 1. In this situation, the structure 101 and the real objects may be selected and configured to substantially match the corresponding components in the real environment 145, as shown by the inclusion in the real environment 145 in FIG. 1 of similar-looking corresponding components.

Similarly, the images that are delivered to the display screen walls 107 and 109 may mimic what the individual 111 would see if he were in the real environment and had been interacting with the real environment as the individual 111 is interacting with the simulated environment.

To accomplish this, photographs and videos of the real environment may be taken and used in the construction of the simulated environment and in the creation of the library of images that are stored in the image storage system 133.

It may also be possible to position cameras in the real environment, such as cameras 141 and 143 in the real environment 145. The camera 141 may be pointed in the very direction of the imagery that the projector 117 may be directed by the processing system 119 to project in the opening of the window 125. Similarly, the camera 143 may be pointed in the very direction of the imagery that the projector 119 may be directed by the processing system 131 to project on the opening in the door 123. The signals from the cameras 141 and 143 may be delivered to the processing system 131 over the communication link 135, as also shown in FIG. 1.

A computer-controlled sensory generator 151 may also be included in association with the structure 101. Although illustrated as a single device in the corner of the room, it is to be understood that the sensory generator 151 may, in fact, be several devices located at various locations.

The sensory generator 151 may be configured to controllably generate matter or energy that is detectable by the human senses, such as by the human senses of the individual 111. The processing system 131 may be in communication with the sensory generator 151 so as to control the sensory generator to add additional realism to the simulated environment. The control of the sensory generator may be a function of the interaction between the individual 111 and the scene, as sensed by the sensors, such as the sensor 127.

The sensory generator 151 may include sound-generating apparatus, such as immersive audio systems and echo-generating systems. These can replicate the sounds that the individual 111 would expect to hear from the images that are being projected on the display screen walls 107 and 109, such as gunfire, thunder, voices, the rumbling of a tank, and the whirling of a helicopter blade.

The sensory generator 151 may also include movement-generating apparatus, such as devices that shake the walls or floors of the structure 101, again to reflect what might be expected to be felt from many of these projected images.

The movement-generating apparatus may also move objects in the room, such as causing pictures on a wall to fall, glass to break, or even the floor to move violently to simulate an earthquake.

The movement-generating apparatus may also cause air to move, such as to simulate wind.

The sensory generator 151 may also generate particulate material, for example, droplets simulating rain or a mist simulating fog.

The sensory generator 151 may also include one or more lights, such as one or more strobes to assist in the simulation of lightning or an explosion.

The sensory generator 151 may also include temperature changing apparatus so as to cause temperature changes, providing even further flexibility in the types of environments that may be simulated.

The components that interact together to create the interactive environment may be designed in the form of modules. The same set of modules may be used to create a vast variety of different types of simulated environments.

The use of projected wall textures may be particularly helpful by allowing the same display screen wall to be used with different projected images, so as to create the virtual appearance of a broad variety of different types of walls.

The modules may also be fitted with releasable connections so that one module may be readily attached to and detached from another module. This may facilitate the ready assembly, disassembly, packaging, shipment and re-assembly of a broad variety of simulated environments from the same set of modules.

As is well known in the art, a broad variety of connection systems may be used to implement this releasable function. Such systems include latching mechanisms and deformable male projections and female receptacles that allow modular-like components to be easily snapped or slid together and just as easily snapped or slid apart. Traditional fasteners, such as nuts and bolts, may also be used.

The size of each modular component may also be kept to a specified maximum. If this is exceeded by the needed size of a large wall, the large wall may be made up by releasably connecting a set of smaller wall segments.

Heavy pieces may also have wheels placed along their bottom edge, such as wheels 231 shown in FIG. 2 or wheels 341 shown in FIG. 3, to make it easier to relocate them.

FIG. 4 illustrates an interactive environment that is partially real and partially simulated of a different configuration. As shown in FIG. 4, the interactive environment includes rooms 401, 403, 405 and 407, each with associated windows 409, 411, and 413 and 421 and doors 415, 417, 419 and 421. Display screen wall 423, 425, 427, 429 and 430 may also be included and, in conjunction with projectors 431, 433, 435, 437 and 439, may make displays of the type discussed above.

The specific details of this embodiment may follow one or more of the details discussed above in connection with FIGS. 1-3. When constructed out of the type of modular components discussed above, the simulated environment in FIG. 4 can be easily and quickly constructed out of these very same components and with no added expense. This illustrates the great flexibility and power of the modular system

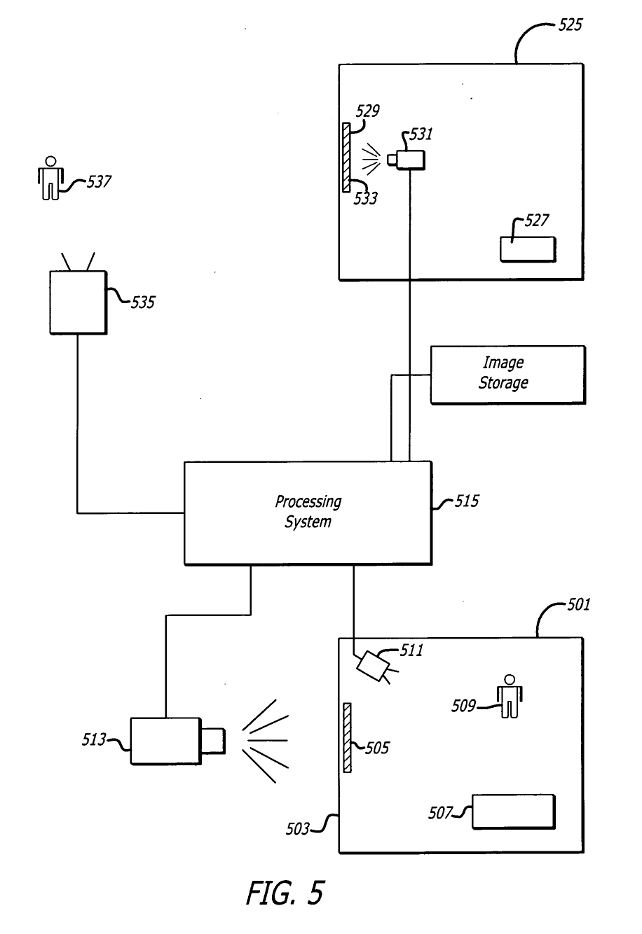

FIG. 5 illustrates a distributed, interactive environment that is partially real and partially simulated. As shown in FIG. 5, a first structure 501 may include a display screen wall 503, a real window 505 and a desk 507. An individual 509 may be within the structure 501. The interaction between the individual and the scene created by the structure 501 and its associated real objects may be sensed by a sensor 511. A projector 513 may be directed to the display screen wall 503 creating in combination with the display screen wall a computer-controlled display.

A second and complementary environment may include a complementary set of components, including a second structure 525, desk 527, real window 529, projector 531, display screen wall 533 within the window 529 and sensor 535 configured to sense the interaction between a second individual 537 and the environment created by the second structure 525 and its associated components.

A processing system 515 may be in communication with the projectors 513 and 531 and the sensors 511 and 535.

The configuration shown in FIG. 5 can be useful in training or testing a group of individuals, without requiring the group to be at the same location.

All of the individuals may interact with the same mixed reality environment. In this situation, all of the corresponding components between the two environments may be the same or substantially the same, to the extent possible. Although only two distributed environments and two individuals have been shown in FIG. 5, it is to be understood that a different number of either or both could also be used.

All of the components shown in FIG. 5 may be configured to operate as described above in connection with the components shown in FIGS. 1-4. To accomplish interaction, however, the processing system 515 may be configured to cause images that are sent to the projector 513 to be a function of the interaction between the second individual 537 and the scene he is associate with, as detected and/or measured by the sensors 535. Similarly, the sequence of images that the processing system 515 delivers to the projector 531 may be a function of the interaction between the first individual 509 and the scene with which he is associated, as detected by the sensors 511. The processing system 515 may also take into consideration the signals generated by the sensor that is in the same scene as the projector in selecting the image to be displayed in that scene.

One application of this distributed environment is the sniper example discussed above. Instead of the sniper being a wholly virtual image, however, that sniper may actually be the real individual 537 shown in FIG. 5. As can readily be imagined, the processing system 515 may cause an image of the first individual 509 to be projected on the screen display 533, creating a virtual target for the second individual 537. Conversely, the processing system may cause an image of the second individual 537 to be cast upon the display screen wall within the portal of the window 505, creating a target for the first individual 509. As each of the individuals react to their respective targets, the interaction between the individuals and their scene can be detected and/or measured by the sensors 511 and 535, respectively, causing the processing system 515 to appropriately adjust the next set of images that are delivered to the display being viewed by each individual. Because of the seamless integration of real and virtual components in each environment, the mixed reality systems may provide the illusion to each individual of a completely real environment.

The images that are delivered to the projectors 513 and 531 may be synchronized in some manner to one another, such as the delivery of identical images being delivered to both projectors. The selection and/or the timing of the images may also be a function of a stimulus other than or in addition to the stimulus detected by the sensors 511 and 535. For example, the stimulus could be a signal from a trainer that is monitoring an interactive environment that is configured for training that initiates the simulation of an explosion.

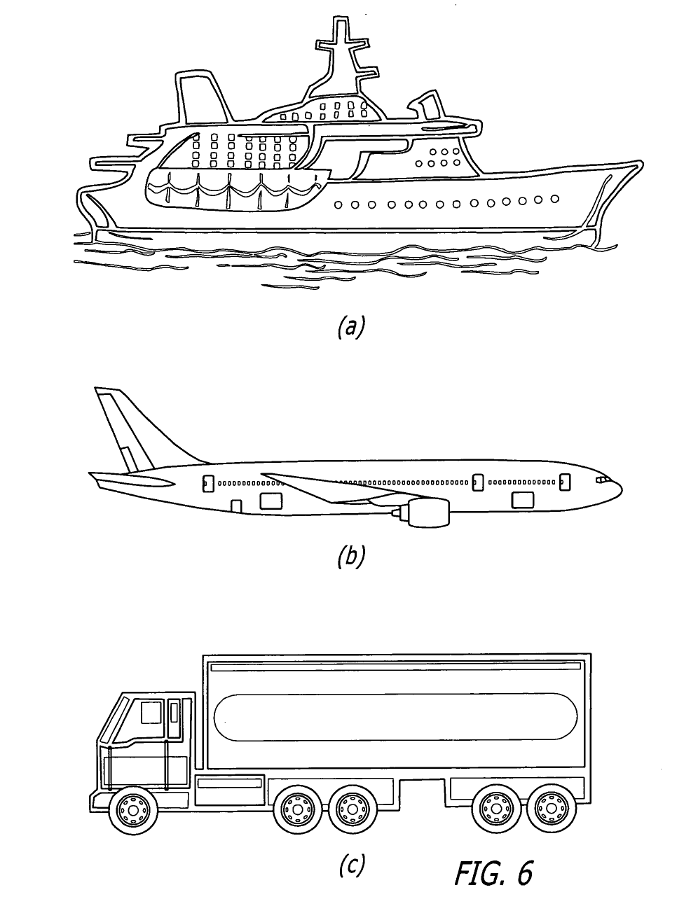

Although one or more rooms have thus-far been illustrated as the structure of the environment, it is to be understood that a broad variety of different structures can be created and operated using the same principles. These include buildings with multiple floors and multiple rooms, geographic areas that contain several buildings, alleyways, streets and associated structures, and vessels, such as the ship, plane or freight truck shown in FIGS. 6(a), (b) and (c), respectively.

Although only a single individual has thus-far been shown in each structure, it is to be understood that each structure could be large enough to accommodate a plurality of individuals, both before and after each takes several displacement steps, either horizontally, vertically or in some other direction. The structures may even be large enough to allow the individuals to walk many steps or to even run.

Although certain real objects have thus-far been illustrated to enhance the realism of the scene, it is to be understood that other real objects could also be used, such as pictures, floors, fans, lighting, carpeting, bookshelves, wallpaper and ceilings. All of the real objects may also be part of the modular system discussed above, making them easy to assemble, disassemble, transport and reassemble.

Although only rear-projection displays have thus-far been illustrated, it is to be understood that any type of display can be used, including front projection displays and flat displays, such as large plasma displays and electronic ink devices.

The image that is delivered to a display may also be a stereoscopic image suitable for generating a three-dimensional effect. The display that receives this image may also be one that is suitable for displaying the stereoscopic image so as to create the three-dimensional effect. The image that the individual views within the scene may then appear to change in perspective as the individual changes her position relative to the display, thus adding to the realism. The individual may wear appropriate 3-D glasses to realize this effect or, in connection with emerging 3-D technologies, wear nothing additional at all.

The partially real and partially simulated modular interactive environment that has thus-far been described may be used in connection with a broad variety of applications, including simulations of military operations, architecture and interior design. It may be used in connection with theatrical presentations, location-based entertainment, theme parks, museums and in training and testing situations. Other applications are also embraced. The position of each display screen wall, such as the display screen walls 107 and/or 109, may be adjusted to precisely match the position that the walls need to be in so that the image they project is correctly located in the scene that the walls help to create. The image that is projected on each display screen wall, including its perspective, may additionally or instead be adjusted by the processing system to effectuate the same result.

To help in this process, one or more additional sensors may be provided to sense the position of one or more of the display screen walls. Such sensors may or may not be attached to the display screen walls and may be optical, magnetic, utilize the GPS system, or may be of any other type. The information provided by these sensors may then be used to help position the walls precisely and/or to cause the image that is projected on them to be adjusted by the processing system, as discussed above.

Although certain embodiments have now been described, it is to be understood that the features, components, steps, benefits and applications of these technologies are not so limited and that the scope of this application is intended to be limited solely to what is set forth in the following claims and to their equivalents.

We claim:

1. An interactive environment that is partially real and partially simulated comprising:
a structure that is large enough to accommodate an individual both before and after the individual takes a plurality of displacement steps within the structure;
at least one real, three-dimensional object positioned within the structure, the real object and the structure cooperating to form a seamless and integrated scene;
at least one computer-controlled display fixedly positioned within the scene such that each image displayed by the display appears to the individual to be real, three-dimensional and an integral and seamless part of the scene;
at least one sensor configured to sense interaction between the individual and the scene; and
a processing system in communication with the sensor and the display and configured to deliver a sequence of images to the display, the content of which are a function of the interaction between the individual and the scene, including a plurality of displacement steps taken by the individual.

2. The interactive environment of claim 1 wherein the display is configured and positioned so as to appear to the individual to be an integrated and seamless part of the scene that is something other than a display.

3. The interactive environment of claim 2 wherein the display is part of the structure.

4. The interactive environment of claim 3 wherein the display includes a wall of the structure.

5. The interactive environment of claim 4 wherein one of the images includes an image of wall texture and wherein the processing system is configured to deliver the image of the wall texture to the display.

6. The interactive environment of claim 4 wherein a real, operable door is positioned in front of the wall of the display.

7. The interactive environment of claim 4 wherein a real window is positioned in front of the wall of the display.

8. The interactive environment of claim 7 wherein the window can be physically opened or closed.

9. The interactive environment of claim 8 wherein the window includes operable shutters.

10. The interactive environment of claim 1 wherein:
the interactive environment is configured to simulate a real environment having a similar structure, a similar real object and a scene beyond the structure;
one of the images includes an image of the scene beyond the structure;
the interactive environment includes a real or virtual door or window;
at least a portion of the display is oriented within the opening of the door or window; and
the processing system is configured to deliver the image of the scene beyond the similar structure to the display.

11. The interactive environment of claim 1 wherein one or more of the images are selected by the processing system from a library of images stored on an image storage device.

12. The interactive environment of claim 1 wherein the interactive environment is configured to simulate a real environment and wherein one or more of the images are captured from the real environment.

13. The interactive environment of claim 12 wherein the images that are captured from the real environment are delivered by the processing system to the display in real time.

14. The interactive environment of claim 1 wherein the structure, display and real object are configured in the form of modules that releasably connect to and disconnect from one another to facilitate the assembly, disassembly, shipment and re-assembly of the interactive environment in various different configurations from the modules.

15. The interactive environment of claim 15 wherein a portion of the structure, the display or the real object includes wheels for easy transport.

16. The interactive environment of claim 1 wherein the structure is large enough to accommodate a plurality of individuals both before and after each individual takes a plurality of displacement steps.

17. The interactive environment of claim 1 wherein the structure, display and real object cooperate to create the environment of a room.

18. The interactive environment of claim 1 wherein the structure, display and real object cooperate to create the environment of a building having a plurality of rooms.

19. The interactive environment of claim 1 wherein the structure, display and real object cooperate to create the environment of an alleyway.

20. The interactive environment of claim 1 wherein the structure, display and real object cooperate to create the environment of a land, sea or air vessel.

21. The interactive environment of claim 1 further including computer-controlled sensory generator, other than a display, configured to controllably generate matter or energy that is detectable by one or more of the human senses, and wherein the processing system is also in communication with the generator and is configured to control the generation of such matter or energy.

22. The interactive environment of claim 21 wherein the processing system is configured to control the generator as a function of the interaction between the individual and the scene.

23. The interactive environment of claim 21 wherein the generator includes sound-generating apparatus.

24. The interactive environment of claim 21 wherein the generator includes movement-generating apparatus.

25. The interactive environment of claim 24 wherein the movement generating apparatus includes floor movement generating apparatus.

26. The interactive environment of claim 24 wherein the movement generating apparatus includes air movement generating apparatus.

27. The interactive environment of claim 21 wherein the generator includes a light.

28. The interactive environment of claim 21 wherein the generator includes temperature-changing apparatus.

29. The interactive environment of claim 1 wherein one or more images are stereoscopic images and wherein the display is configured to display the stereoscopic images.

30. A distributed interactive environment that is partially real and partially simulated comprising:
a first computer-controlled display fixedly positioned within a first scene such that each image on the first display appears to a first individual in the first scene to be real, three-dimensional and an integral and seamless part of the first scene;
a first sensor configured to sense interaction between the first individual and the scene;
a second computer-controlled display fixedly positioned within a second scene such that each image on the second display appears to a second individual in the second scene to be real, three-dimensional and an integral and seamless part of the second scene, the second scene being substantially the same as the first scene, but separated geographically from the first scene;
a second sensor configured to sense interaction between the second individual and the second scene; and
a processing system in communication with the first and second displays and the first and second sensors and configured to deliver a sequence of images to the first display the content of which are a function of the interaction between the second individual and the second scene and to deliver a sequence of images to the second display the content of which are a function of the interaction between the first individual and the first scene.

31. A distributed interactive environment that is partially real and partially simulated comprising:
a first computer-controlled display fixedly positioned within a first scene such that each image on the first display appears to a first individual in the first scene to be real, three-dimensional and an integral and seamless part of the first scene;
a second computer-controlled display fixedly positioned within a second scene such that each image on the second display appears to a second individual in the second scene to be real, three-dimensional and an integral and seamless part of the second scene, the second scene being substantially the same as the first scene, but separated geographically from the first scene; and
a processing system in communication with the first and second displays and configured to deliver a sequence of images to the first and second displays that are synchronized to one another and that are a function of a external stimulus.

32. A modular, interactive environment comprising:
a set of modular walls that releasably connect to and disconnect from one another to facilitate the assembly, disassembly, shipment and re-assembly of the interactive environment in various different configurations, at least one of the walls being a computer-controlled display configured such that images on the display appear to an individual within the environment created by the walls to be real, three-dimensional and an integral and seamless part of the environment;
at least one sensor configured to sense interaction between an individual and the environment created by the modular walls; and
a processing system in communication with the sensor and the display and configured to deliver images to the display that vary based on the interaction between the individual and the environment.

33. A simulated environment comprising:
a wall that forms part of a computer-controlled display configured in the environment such that images projected on the wall appear to an individual within the environment to be real, three-dimensional and an integral and seamless part of the environment; and
a sensor configured to sense the location of the wall within the environment.
